(19) United States
(12) Patent Application Publication
(10) Pub. No.: US 2018/0230341 A1
(43) Pub. Date: Aug. 16, 2018

(54) DAMPING HOT MELT COMPOSITION

(71) Applicant: HENKEL AG & CO. KGAA, Duesseldorf (DE)

(72) Inventors: Xin BAI, Shanghai (CN); Yew-Guan LOW, Shanghai (CN); Qi CHEN, Shanghai (CN)

(21) Appl. No.: 15/953,543

(22) Filed: Apr. 16, 2018

Related U.S. Application Data
(63) Continuation of application No. PCT/CN2015/093360, filed on Oct. 30, 2015.

(51) Int. Cl. C09J 9/00; C09J 123/08; C09J 123/14; C09J 11/04; G10K 11/162

(52) U.S. Cl. CPC C09J 9/00; C09J 123/0853; G10K 11/162; C09J 11/04; C09J 123/14

(57) ABSTRACT

The present invention relates to a hot melt composition, which is suitable as a dampening, preferably a sound deadening, composition comprising,
i) at least one poly-α-olefin;
ii) at least one elastomeric styrene based copolymer;
iii) at least one thermoplastic polymer having a melt index of 50 to 5000 at 190° C./2.16 kg selected from ethylene vinyl acetate (EVA), ethylene acrylic acid (EAA), alkyl acrylates, alkyl methylacrylates (EMA), ethylene 2-ethyl hexyl acrylate (EEHA) or combinations thereof; and optionally
iv) at least one additive, preferably selected from fillers; stabilizers; colorants; pigments; waxes; polymers which are different from i) to iii); moisture scavengers; or combinations thereof. Furthermore, the present invention relates to a dampening, preferably a sound deadening, article comprising the hot melt composition of the present invention and the use of the hot melt composition of the present invention in dampening, preferably sound deadening.

### FIELD OF THE INVENTION

The present invention relates to a specific hot melt composition which is suitable as a damping, preferably a sound deadening composition. Furthermore, the invention relates to the use of the hot melt composition according to the present invention in dampening, preferably sound deadening, more preferably in damping, preferably sound deadening, mats, pads, sheets and tapes most preferably in damping, preferably sound deadening, mats, pads, sheets and tapes for the automotive industry, especially in car bodies. The hot melt compositions according to the present invention show a low volatile-organic-compound (VOC) and fogging release.

### BACKGROUND OF THE INVENTION

Damping and/or sound deadening materials, also referred to as sound deadening materials or as damping materials only in the following, are widely used in transportation, appliances and constructions to reduce noise, vibration and harshness. In the automotive field, interior floor pans, roofs and doors of a car need damping materials to decrease structure-borne noise that can be transmitted through car-body substrates. Materials with good damping and/or sound deadening performance, low density and low volatile-organic-compound (VOC) release at the application temperature are highly appreciated in the automotive industry.

According to the application methods in car bodies, there are two kinds of damping materials. One kind of damping material is pre-cut pieces of melt pads which are made of asphaltic materials, butylene rubbers or pressure sensitive adhesives (PSA). The other kind of damping material is sprayable coatings which are also referred to as liquid applied sound deadeners.

For example WO 2015/135114 A discloses polyolefin based sound deadening hot melt compositions. Even though the disclosed adhesives have good sound deadening performance the low volatile-organic-compound (VOC) release of the disclosed adhesives is not satisfying. Therefore, there exist a need in the automotive market for improved polyolefin based sound deadening hot melt compositions which show less low volatile-organic-compound release while having a damping, preferably good sound deadening, performance.

### SUMMARY OF THE INVENTION

Common hot melt adhesives compositions require a tackifier in order to impart tackiness to the adhesive. However, tackifier are often prone to decomposition, especially after melting at high temperatures and thus they are the main source for the volatile-organic-compound (VOC) release.

It has been surprisingly found by the present inventors that this disadvantage can be overcome by a hot melt composition in which the tackifier has been replaced by at least one thermoplastic polymer having a melt index of 50 to 5000 at 190° C./2.16 kg selected from ethylene vinyl acetate (EVA), ethylene acrylic acid (EAA), alkyl acrylates, alkyl methylacrylates (EMA), ethylene 2-ethyl hexyl acrylate (EEHA) or combinations thereof. In particular by a hot melt adhesive composition comprising, at least one poly-α-olefin, at least one elastomeric styrene based copolymer and at least one thermoplastic polymer having a melt index of 50 to 5000 at 190° C./2.16 kg selected from ethylene vinyl acetate (EVA), ethylene acrylic acid (EAA), alkyl acrylates, alkyl methylacrylates (EMA), ethylene 2-ethyl hexyl acrylate (EEHA) or combinations thereof.

### DETAILED DESCRIPTION OF THE INVENTION

In the present specification the terms “a” and “an” and “at least one” are the same as the term “one or more” and can be employed interchangeably.

In the present specification the term “essentially” is to be interpreted within the common expectation of the skilled person in the respective field. Preferably the term “essentially” is to be interpreted that the specific compounds referred to are contained in at least 98 wt.-%, 99 wt.-%, 99.5 wt.-%, 99.8 wt.-%, 99.9 wt.-% of the total composition, more preferably at least 99.9 wt.-%, most preferably 99.99 wt.-%.

The term “essentially free” within the context of this invention is to be interpreted as the respective compound is contained in the composition in an amount of less than 5 wt.-%, 4 wt.-%, 3 wt.-%, 2 wt.-%, 1.5 wt.-%, 1 wt.-%, 0.75 wt.-%, 0.5 wt.-%, 0.25 wt.-%, or 0.1 wt.-%, based on the total weight of the composition, wherein the amounts are respectively more preferred in descending order. For example, 4 wt.-% is more preferred than 5 wt.-% and 3 wt.-% is more preferred than 4 wt.-%.

In particular the present invention relates to
1. A hot melt composition, which is suitable as a dampening, preferably a sound deadening, composition comprising, preferably essentially consisting of, more preferably consisting of,
   i) at least one poly-α-olefin;
   ii) at least one elastomeric styrene based copolymer;
   iii) at least one thermoplastic polymer having a melt index of 50 to 5000 at 190° C./2.16 kg selected from ethylene vinyl acetate (EVA), ethylene acrylic acid (EAA), alkyl acrylates, alkyl methylacrylates (EMA), ethylene 2-ethyl hexyl acrylate (EEHA) or combinations thereof; and optionally
   iv) at least one additive, preferably selected from fillers; stabilizers; colorants; pigments; waxes; polymers which are different from i) to iii); moisture scavengers; or combinations thereof.
2. The hot melt composition according to item 1, wherein
   i) is at least one propylene based poly-α-olefin which has been obtained by metallocene catalysis; preferably wherein the at least one propylene based poly-α-olefin has a Melt Flow Rate (MFR) of less than 100 g/10 min, more preferably less than 50 g/10 min, most preferably less than 25 g/10 min measured at 230° C./2.16 kg according to ASTM D1238; and/or
   preferably the propylene content in the propylene based poly-α-olefin is more than 50 wt %, more preferably more than 60 wt %, most preferably more than 70 wt %.
3. The hot melt composition according to item 1 or 2, wherein the at least one poly-α-olefin has a weight average molecular weight of at least 1,000 g/mol, preferably 5,000 g/mol, more preferably 10,000 g/mol; and/or
   preferably the upper limit is at most 100,000 g/mol, more preferably 80,000 g/mol, most preferably 60,000 g/mol.
4. The hot melt composition according to any of items 1 to 3, wherein
   i) is selected from copolymers of propylene and a comonomer selected from at least one C2 to C8 alkylene, preferably i) is a propylene ethylene copolymer.
5. The hot melt composition according to any of items 1 to 4, wherein
   ii) the at least one elastomeric styrene based copolymer is selected from the group consisting of a styrene-isoprene-styrene block copolymers; styrene-isoprene-styrene/styrene-isoprene block copolymers; styrene-butadiene-styrene block copolymers; styrene-butadiene-styrene/styrene-butadiene block copolymers; styrene-butadiene block copolymers; styrene-ethylene-butylene-styrene block copolymers; styrene-ethylene-butylene-styrene/styrene-ethylene-butylene block copolymers; and styrene-ethylene-propylene-styrene/styrene-ethylene-propylene block copolymers; and combinations thereof,
   preferably ii) is selected from styrene-isoprene copolymers; styrene-isoprene-styrene block copolymers or combinations thereof.
6. The hot melt composition according to item 5, wherein the elastomeric styrene based copolymer has a weight average molecular weight of at least 1,000 g/mol, preferably 5,000 g/mol, more preferably 10,000 g/mol; and/or
   preferably the upper limit is at most 100,000 g/mol, more preferably 80,000 g/mol, most preferably 60,000 g/mol.
7. The hot melt composition according to any one of items 1 to 6, wherein
   iii) comprises at least one ethylene vinyl acetate polymer,
   preferably the ethylene vinyl acetate polymer has a vinyl acetate content of 15 to 40 wt.-%, more
   preferably 20 to 30 wt.-%, based on the ethylene vinyl acetate polymer and/or
   preferably the ethylene vinyl acetate polymer has a melt viscosity of 1,000 to 25,000 mPas, more preferably 5,000 to 15,000 mPas, most preferably 8,000 to 10,000 mPas at 190° C. measured according to ASTM D3236.
8. The hot melt composition according to any one of items 1 to 7, wherein
   the hot melt composition is essentially free of a tackifier,
   preferably wherein the hot melt composition is free of a tackifier.
9. The hot melt composition according to any one of items 1 to 8, wherein
   i) is present in an amount of 10 to 45 wt.-%, preferably 15 to 35 wt.-% most preferably 18 to 30 wt.-%, based on the total weight of the composition.
10. The hot melt composition according to any one of items 1 to 9, wherein
   ii) is present in an amount of 1 to 25 wt.-%, preferably 5 to 20 wt.-% most preferably 7 to 15 wt.-%, based on the total weight of the composition.
11. The hot melt composition according to any one of items 1 to 10, wherein
   iii) is present in an amount of 1 to 35 wt.-%, preferably 5 to 30 wt.-% most preferably 10 to 25 wt.-%, based on the total weight of the composition.
12. The hot melt composition according to any one of items 1 to 11, wherein
   iv) is present in an amount of 10 to 60 wt.-%, preferably 20 to 55 wt.-% most preferably 35 to 50 wt.-%, based on the total weight of the composition.
13. A damping, preferably a sound deadening, article comprising, preferably essentially consisting of, more preferably consisting of the hot melt composition according to any one of items 1 to 12.
14. Use of the hot melt composition according to any one of items 1 to 12 in damping, preferably sound deadening, more preferably in damping, most preferably sound deadening, mats, pads, sheets and tapes.

The hot melt composition according to the present invention comprises at least one propylene based poly-α-olefin which is obtainable by metallocene catalysis.

The manufacture of propylene based poly-α-olefins by metallocene catalysis is common in the art and the skilled person knows how to obtain such polymers. Examples on how to obtain such polymers are given for example in the general textbook J. Scheirs, W. Kaminsky, “Metallocene-based Polyolefins, Preparation, Properties, and Technology”, 2 Volume Set 1999, Wiley (ISBN: 978-0-471-98086-5).

The at least one propylene based poly-α-olefin can be a propylene homopolymer or a copolymer. Preferably the propylene based poly-α-olefin is selected from copolymers of propylene and a comonomer selected from at least one C2 to C8 alkylene, more preferably it is a propylene octylene copolymer or a propylene ethylene copolymer, most preferably it is a propylene ethylene copolymer.

The at least one propylene based poly-α-olefin has preferably a Melt Flow Rate (MFR) of less than 100 g/10 min, more preferably less than 50 g/10 min, most preferably less than 25 g/10 min measured at 230° C./2.16 kg according to ASTM D1238.

The at least one propylene based poly-α-olefin has preferably a propylene content of more than 50 wt.-%, more preferably more than 60 wt.-%, most preferably more than 70 wt.-%, based on the total weight of the respective propylene based poly-α-olefin.

The at least one propylene based poly-α-olefin has preferably a density of 0.8 to 1.2 g/m³, more preferably 0.8 to 1.0 g/m³, measured according to ASTM D1505.

Commercial available examples which are suitable as the at least one propylene based poly-α-olefin according to the invention are sold by Dow Chemical Co. under the trade name Engage or Versify, from Clariant under the trade name LICOCENE and from ExxonMobil Chemical under the trade name Vistamaxx, especially Vistamaxx 6202, Exact or LINXA.

The at least one poly-α-olefin preferably has a weight average molecular weight of at least 1,000 g/mol or 2,000 g/mol, or 3,000 g/mol or 4,000 g/mol, more preferably 5,000 g/mol or 6,000 g/mol, or 7,500 g/mol, most preferably 10,000 g/mol. It preferably has an upper limit of at most 100,000 g/mol or 90,000 g/mol, more preferably 80,000 g/mol or 70,000 g/mol, most preferably 60,000 g/mol. Any of the before mentioned upper limits can be combined with any of the before mentioned lower limits.

The hot melt composition of the present invention further comprises at least one elastomeric styrene based copolymer.

The manufacture of one elastomeric styrene based copolymer is common in the art and the skilled person knows how to obtain such polymers. Examples on how to obtain such polymers are given, e.g., in the paper of R. Velichkova et. Al. Journal of Polymer Science Part A: Polymer Chemistry, Vol. 29, Issue 8, pages 1107-1112 or in EP 1925637 A1 where respective copolymers are disclosed as component (a).

Preferably the at least one elastomeric styrene based copolymer is selected from the group consisting of styrene-isoprene-styrene block copolymers; styrene-isoprene-styrene/styrene-isoprene block copolymers; styrene-butadiene-styrene block copolymers; styrene-butadiene-styrene/styrene-butadiene block copolymers; styrene-butadiene block copolymers; styrene-ethylene-butylene-styrene block copolymers; styrene-ethylene-butylene-styrene/styrene-ethylene-butylene block copolymers; and styrene -ethylene-propylene-styrene/styrene-ethylene-propylene block copolymers; and combinations thereof. Most preferably the rubbery polymer is selected from styrene-isoprene copolymers; styrene-isoprene -styrene block copolymers or combinations thereof.

The elastomeric styrene based copolymers of the present invention have preferably a styrene content of 1 to 30 wt.-% or 5 to 25 wt.-%, more preferably 10 to 22 wt.-%, most preferably 15 to 20 wt.-% based on the total weight of the respective copolymer.

The elastomeric styrene based copolymers of the present invention have preferably a specific gravity measured according to ISO 1183 of 0.9 to 1.0, more preferably 0.92 to 0.97.

The elastomeric styrene based copolymers of the present invention have preferably a glass transition temperature of −25 to −5 ° C., more preferably −20 to −10, measured with DSC at a heating rate of −10° C./min.

The elastomeric styrene based copolymers of the present invention have preferably a Shore A Hardness of 30 to 80, more preferably 40 to 70, most preferably 50 to 65 measured according to DIN ISO 7619-1.

The rubbery polymer of the present invention have preferably a weight average molecular weight of at least 1,000 g/mol, or 2,500 g/mol more preferably 5,000 g/mol, or 7,500 g/mol most preferably 10,000 g/mol. It preferably has an upper limit of at most 100,000 g/mol, or 90,000 g/mol, more preferably 80,000 g/mol, or 70,000 g/mol or most preferably 60,000 g/mol.

Commercial available examples which are suitable as the at least one propylene based poly-α-olefin according to the invention are sold by Dow Chemical Co. under the trade name Engage or Versify, from Clariant under the trade name LICOCENE and from ExxonMobil Chemical under the trade name Vistamaxx, especially Vistamaxx 6202, Exact or LINXA.

The hot melt composition of the present invention further requires at least one thermoplastic polymer having a melt index of 50 to 5000 at 190° C./2.16 kg (measured according to ASTM D1238) selected from ethylene vinyl acetate (EVA), ethylene acrylic acid (EAA), alkyl acrylates, alkyl methylacrylates (EMA), ethylene 2-ethyl hexyl acrylate (EEHA) or combinations thereof. In preferred embodiments the melt index is 250 to 4000 at 190° C./2.16 kg, more preferably 500 to 3000 at 190° C./2.16 kg, most preferably 700 to 2000 at 190° C./2.16 kg (measured according to ASTM D1238). In even more preferred embodiments the at least one thermoplastic polymer comprises an ethylene vinyl acetate (EVA), preferably having one of the melt indexes as above-mentioned.

The ethylene vinyl acetate (EVA), ethylene acrylic acid (EAA), alkyl acrylates, alkyl methylacrylates (EMA), ethylene 2-ethyl hexyl acrylate (EEHA) have preferably a density of from 0.85 to 0.99 g/cm³, more preferably 0.9 to 0.97 g/cm³, most preferably 0.95 to 0.96 g/cm³ (measured according to ASTM D1505).

The ethylene vinyl acetate (EVA), ethylene acrylic acid (EAA), alkyl acrylates, alkyl methylacrylates (EMA), ethylene 2-ethyl hexyl acrylate (EEHA) have preferably a melt viscosity (at 190° C.) of 500 to 20,000 mPas, more preferably 1,000 to 10,000 mPas, most preferably 5,000 to 9,000 mPas (measured according to ASTM D3236).

These thermoplastic polymers are common in the art and a skilled person knows how to obtain those polymers. Commercial available examples which are suitable as the at least one thermoplastic polymer according to the invention are sold by ExxonMobil Chemical under the trade name Escorene, especially Escorene UL 8705.

The hot melt composition of the present invention can optionally further comprise at least one additive. The at least one additive is preferably selected from fillers; stabilizers; colorants; pigments; waxes; polymers which are different from i) to iii); moisture scavengers; or combinations thereof.

To obtain the hot melt the different components are blended together by common technics in the art. This can be done in any known device, e.g., batch reactor, extruder, mixer, kneader or similar machines.

### EXAMPLES

### Test Methods

### Molecular Weight Determination

The respective compounds/compositions can be analysed for number average or weight average molecular weight by Gel Permeation Chromatography (GPC). The number average molecular weight (Mn) and weight average molecular weight (Mw) can be determined based on an external calibration that is carried out with polystyrene standards.

Damping Loss Factor

The damping loss factor was determined according to the standard test method ASTM E765-05 and denoted as CLF (composite loss factor). The damping loss factor at 200 Hz was obtained through the interpolation between the 2^{nd} and 3^{rd} order frequency damping ratio following the method in SAE J1637-07.

The length of the substrate metal bar was 240 mm, the thickness of the substrate metal bar was 1 mm and the width of the substrate metal bar was 10 mm. The sample length on top of the substrate was 216 mm All The samples thickness were 2.5 mm and all the samples width were 10 mm.

Fogging Test

In this procedure, the test specimen is heated in a beaker assembly in a fog testing unit. A fog testing unit has a controlled heating unit with multiple chambers for a typical temperature range from 60° C. to 120° C. Cooling of the glass plate for each beaker in the unit is required with a typical temperature range from 20° C. to 40° C. The heating unit and the cooling system must be able to maintain the temperatures to within ±0.5° C. The cooling plates, which are laid upon the glass plates, should apply a weight of approximately 1 kg to ensure an adequate seal with the beaker. The fog is collected on a glass plate and the fog number is determined by measuring the difference in gloss value according to test method SAE J1756:2006 before and after testing. The higher the measured transmittance the lower the VOC release.

The heating temperature should be 100° C.±0.5° C. and the cooling plate temperature 21° C.±0.5 ° C. for a duration of 3 h±0.05 h, followed by 1 h±0.05 h of conditioning at 21° C. 35 2 ° C. and 50% ±5% RH.

Dampening materials 1 to 5 (examples 1 to 5) were prepared using the components shown in the respective table.

The preparation processes of examples 1 to 5 are the same and are illustrated by the preparation process for example 1 in the following.

First, all components of Example 1 as listed in Table 1 were weighted and mixed in a Z-blade mixer, then poured out and put onto a hot presser, on which the composition was pressed into a sheet with a thickness of 2.5 mm at 140° C. for 1 min, under pressure of 1000 kgf. The source of fogging was first investigated. The fogging test was taken individually of each component.

In the following tables all amount are given in wt.-%, based on the total weight of the respective composition.

### Comparative Examples 1 to 3

TABLE 1

| | Ex. 1 | Ex. 2 | Ex. 3 |
|---|---|---|---|
| Components | (comparative) | (comparative) | (comparative) |
| Vistamaxx 6202 | 20.00 | 19.61 | 19.61 |
| (C3/C2 Poly α-olefin) | | | |
| Hybrar 5125 (SIS Copolymer) | 10.00 | 9.80 | 9.80 |
| Phenolite TD-2640 | 10.00 | 9.80 | 9.80 |
| (Tackifier/alkyl phenolic resin) | | | |
| Escorene UL 8705 (EVA) | 15.00 | 14.71 | 14.71 |
| Graphite (Filler) | 45.00 | 44.12 | 44.12 |
| Activated carbon (Additive) | 0.00 | 1.96 | 0.00 |
| Zeolite (Additive) | 0.00 | 0.00 | 1.96 |
| 200 Hz CLF @ RT | 0.20 | 0.20 | 0.20 |
| Transmittance (%) | 54.5 | 51.7 | 52.8 |

Several porous fillers were chosen to test the ability of absorbing small molecules and thus avoid VOC release.

### Examples 4 and 5

TABLE 2

| Components | Ex. 4 | Ex. 5 |
|---|---|---|
| Vistamaxx 6202 | 20 | 30 |
| (C3/C2 Poly α-olefin) | | |
| Hybrar 5125 (SIS Copolymer) | 10 | 10 |
| UL 8705 (EVA) | 25 | 15 |
| Graphite (Filler) | 45 | 45 |
| 200 Hz CLF @ RT | 0.09 | 0.06 |
| Transmittance (%) | 99.0 | 99.1 |

We have surprisingly found that the common tackifier employed in hot melt adhesives can be replaced by a higher amount of the at least one thermoplastic copolymer. By the replacement the fogging is eliminated and at the same time the initial adhesion is comparable and the damping performance is still good.

1. A hot melt composition, which is suitable as a dampening comprising,
i) at least one poly-α-olefin;
ii) at least one elastomeric styrene based copolymer;
iii) at least one thermoplastic polymer having a melt index of 50 to 5000 at 190° C./2.16 kg selected from ethylene vinyl acetate (EVA), ethylene acrylic acid (EAA), alkyl acrylates, alkyl methylacrylates (EMA), ethylene 2-ethyl hexyl acrylate (EEHA) or combinations thereof; and
iv) optionally, an additive, selected from fillers; stabilizers; colorants; pigments; waxes; polymers which that are different from i) to iii); moisture scavengers; or combinations thereof.

2. The hot melt composition according to claim 1, wherein
i) the at least one poly-α-olefin is at least one propylene based poly-α-olefin which has been obtained by metallocene catalysis.

3. The hot melt composition according to claim 1, wherein the at least one poly-α-olefin has a weight average molecular weight of at least 1,000 g/mol and
less than 100,000 g/mol.

4. The hot melt composition according to claim 1, wherein
i) the at least one poly-α-olefin is selected from copolymers of propylene and a comonomer selected from at least one C2 to C8 alkylene.

5. The hot melt composition according to claim 1, wherein
ii) the at least one elastomeric styrene based copolymer is selected from the group consisting of a styrene-isoprene-styrene block copolymers; styrene-isoprene -styrene/styrene-isoprene block copolymers; styrene-butadiene-styrene block copolymers; styrene-butadiene-styrene/styrene-butadiene block copolymers; styrene -butadiene block copolymers; styrene-ethylene-butylene-styrene block copolymers; styrene-ethylene-butylene-styrene/styrene-ethylene-butylene block copolymers; and styrene-ethylene-propylene-styrene/styrene-ethylene-propylene block copolymers; and combinations thereof.

6. The hot melt composition according to claim 5, wherein the elastomeric styrene based copolymer has a weight average molecular weight of at least 1,000 g/mol, and
less than 100,000 g/mol.

7. The hot melt composition according to claim 1, wherein
iii) the at least one thermoplastic polymer is an ethylene vinyl acetate polymer.

8. The hot melt composition according to claim 1, wherein
the hot melt composition is essentially free of any tackifiers.

9. The hot melt composition according to claim 1, wherein
i) the at least one poly-α-olefin is present in an amount of 10 to 45 wt. %, based on the total weight of the composition.

10. The hot melt composition according to claim 1, wherein
ii) at least one elastomeric styrene based copolymer is present in an amount of 1 to 25 wt. %, based on the total weight of the composition.

11. The hot melt composition according to claim 1, wherein
iii) the at least one thermoplastic polymer is present in an amount of 1 to 35 wt.-%, based on the total weight of the composition.

12. The hot melt composition according to claim 1, wherein
iv) the additive is present in an amount of 10 to 60 wt. %, based on the total weight of the composition.

13. A damping article comprising, the hot melt composition according to claim 1.

14. The article according to claim 13 is a sound deadening mat, sound deadening pad, sound deadening sheet and sound deadening tape.
